(19) United States
(12) Patent Application Publication
(10) Pub. No.: US 2009/0178642 A1
(43) Pub. Date: Jul. 16, 2009

(54) Heat energy recycling device for an engine and two-stroke engine using the same

(76) Inventor: Lai Shi Huang, Pingihen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,718

(22) Filed: Jan. 15, 2008

(51) Int. Cl. F02B 47/02

(52) U.S. Cl. 123/25 D

(57) ABSTRACT

The present invention discloses a heat energy recycling device for an engine and a two-stroke engine using the same, which recycles the heat energy of the exhaust gas of a two-stroke engine and uses a technology of directly injecting high-pressure and high-temperature water into the cylinder. At an appropriate timing, fuel supply is intermitted, and high-pressure and high-temperature water is injected into the cylinder before or at the beginning of the explosion stroke. The high-pressure and high-temperature water vaporizes instantly inside the cylinder because the saturation temperature at the pressure is much lower than the temperature of the water. The water vapor pushes the piston to move and generates a water dynamic stroke. During the water dynamic stroke, the gas inside the cylinder expands, and the temperature thereof decreases. Thus, the gas inside the cylinder has a temperature lower than that of the cylinder and absorbs heat from the cylinder wall. Then, more heat of the cylinder is recycled, and the urgency of installing a heat-dissipation system is decreased. The present invention recycles heat energy from waste gas and the heat-dissipation system to generate dynamic power and realizes a low-fuel consumption and high-compression ratio two-stroke engine.

### BACKGROUND OF THE INVENTION

1. Field of the Invention

The present invention relates to a heat energy recycling device, particularly to a heat energy recycling device for an engine and a two-stroke engine using the same.

2. Description of the Related Art

The internal combustion engine has been a matured technology including many branches, wherein two-stroke engines and four-stroke engines are the most widely used. Four-stroke engines are more stable, oil-saving and environment-friendly than two-stroke engines. However, due to the complicated structure, the volume efficiency of a four-stroke engine is only half that of a two-stroke engine. The cost of parts and mechanical design and the oil consumption of a four-stroke engine are thus increased. In practical application, the energy efficiency of the internal combustion engine is only 20-30%, and more than 70% of energy is dissipated into the atmosphere in form of heat. Because automobiles accelerate and brake frequently, dynamic energy is converted into heat, which further lowers the efficiency of energy. Thus, more fuel oil is burned, and more carbon dioxide and hydrocarbon is released, which aggravates the greenhouse effect of the earth and further increases the demand for fuel oil. Under the anxiety of petroleum supply, the price of fuel oil has risen 300% in recent few years.

Many current automobile researches are directed to develop hybrid vehicles, which are propelled by an internal combustion engine and an electric motor powered by batteries or fuel cells, to overcome the abovementioned problems. However, such a solution has a high cost and many difficulties hindering the popularization thereof.

Two-stroke engines have the advantages of lightweight and small size. However, traditional two-stroke engines also have the disadvantage of lower fuel efficiency because fuel gas mixed with exhausted gas and emit into the exhaust pipe. Besides, one combustion cycle per each two strokes results in high thermal load and greater cooling loss consequently. Furthermore, high cylinder temperature and heat-dissipation difficulty results in high temperature, and the compression ratio is thus hard to increase because knocking is apt to occur at a high compression ratio. In a two-stroke engine, exhausted gas was expelled by intake air out of the cylinder. When the load is low, the amount of intake air is small. Thus, a great amount of high-temperature residual gas is not expelled but remains inside the cylinder to mix with new fuel air, which is apt to cause a high-temperature spontaneous combustion under a high compression ratio. The abovementioned low-load knocking is a characteristic of two-stroke engines and usually hinders the promotion of the compression ratio.

Therefore, the present invention proposes a heat energy recycling device for an engine and a two-stroke engine using the same, which can decrease fuel consumption and increase the efficiency of an internal combustion engine, to overcome the conventional problems.

### SUMMARY OF THE INVENTION

The primary objective of the present invention is to provide a heat energy recycling device for an engine and a two-stroke engine using the same, wherein the high-pressure and high-temperature water heated by the recycled heat energy from the stroke of the explosive combustion of fuel, whereby the fuel efficiency of an engine is promoted.

Another objective of the present invention is to provide a heat energy recycling device for an engine and a two-stroke engine using the same, which can realize a low-fuel consumption and high-compression ratio two-stroke engine.

Further objective of the present invention is to provide a heat energy recycling device for an engine and a two-stroke engine using the same, which can decrease emission and reduce environmental pollution.

To achieve the abovementioned objectives, the present invention proposes a heat energy recycling device for an engine, which comprises: a condenser; an exhaust device having one end connecting with an exhaust outlet of the engine and the other end connecting with the condenser; a water tank store water and recycling the condensed water from the condenser and providing injection water; a high-pressure water pump connecting with the water tank; a high-pressure injection water conduit having one end connecting with the water pump that pressurizes the water inside the high-pressure injection water conduit; and a high-pressure water injector connecting with the other end of the high-pressure injection water conduit and injecting water into a cylinder of the engine to implement a water dynamic stroke.

The present invention also proposes a two-stroke engine having a heat energy recycling device, which comprises: a two-stroke engine and a heat energy recycling device. The two-stroke engine further comprises at least one cylinder, and the cylinder includes at least one exhaust outlet and at least one fuel injector. The heat energy recycling device for the engine comprises: a condenser; an exhaust device having one end connecting with the exhaust outlet of the engine and the other end connecting with the condenser; a water tank store water and recycling the condensed water from the condenser and providing injection water; a high-pressure water pump connecting with the water tank; a high-pressure injection water conduit having one end connecting with the water pump that pressurizes the water inside the high-pressure injection water conduit; and a high-pressure water injector arranged inside the cylinder, connecting with the other end of the high-pressure injection water conduit and injecting water to the cylinder of the engine to implement a water dynamic stroke.

Below, the preferred embodiments will be described in detail in cooperation with the attached drawings to make easily understood the characteristics and efficacies of the present invention.

### BRIEF DESCRIPTION OF THE DRAWINGS

FIG. 1 is a diagram schematically showing a heat energy recycling device according to the present invention;

FIG. 2 is a diagram schematically showing a two-stroke engine using a heat energy recycling device according to the present invention;

FIG. 3 and FIG. 4 are diagrams schematically the fuel dynamic stroke of a two-stroke engine using a heat energy recycling device according to the present invention; and

FIG. 5 to FIG. 8 are diagrams schematically the water dynamic stroke of a two-stroke engine using a heat energy recycling device according to the present invention.

### DETAILED DESCRIPTION OF THE INVENTION

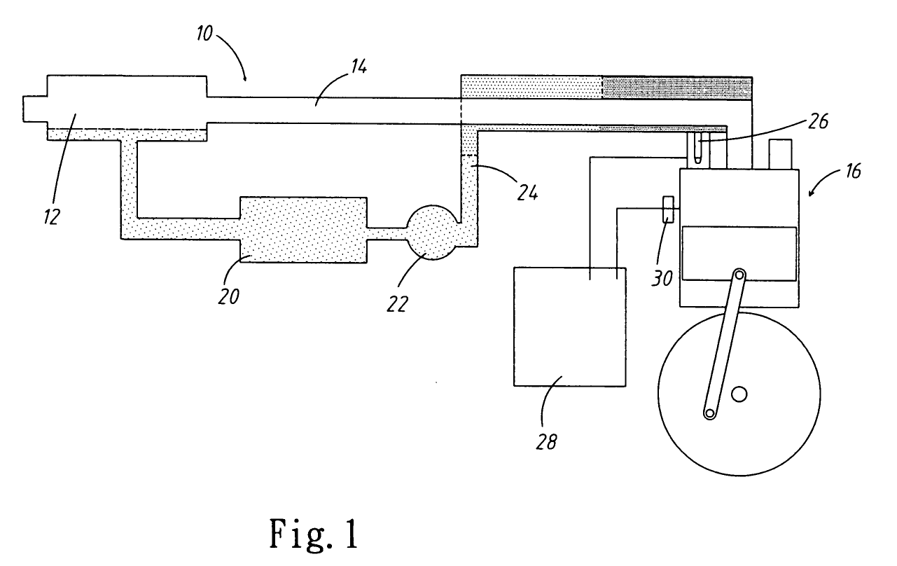

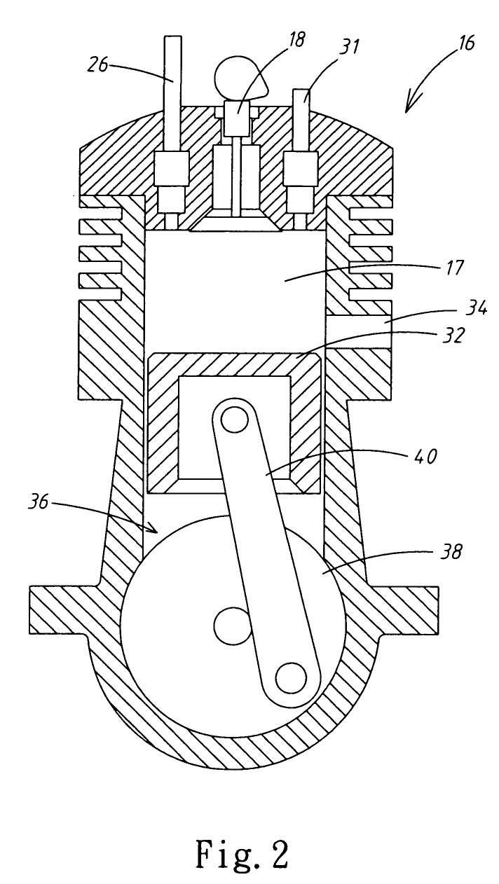

Refer to FIG. 1 and FIG. 2 diagrams schematically showing a heat energy recycling device for an engine according to the present invention. The heat energy recycling device 10 of the present invention comprises: a condenser 12; an exhaust device 14 (with a heat exchanger not shown in the diagrams) having one end connecting with an exhaust outlet 18 of an engine 16 and the other end connecting with the condenser 12; a water tank 20 recycling the condensed water from the condenser 12 and the exhaust device 14 and providing injection water; a high-pressure water pump 22; a high-pressure injection water conduit 24; and a high-pressure water injector 26 arranged inside a cylinder 17 of the engine 16, connecting with the high-pressure injection water conduit 24 to receive the water, which has been pressurized to a pressure over 200 bar or high enough to keep hot water in liquid, and injecting the pressurized water to the cylinder 17 of the engine 16; and a control computer 28 controlling the water injection timing and the water injection amount of the high-pressure water injector 26.

The exhausted gas arriving at the exhaust device 14 and the exhaust outlet 18 of the engine 16 has a temperature as high as 500-800° C. Thus, the high-pressure injection water conduit 24 is wound around the perimeter of the exhaust device 14 or is wound inside the exhaust device 14 to heat the water inside the high-pressure injection water conduit 24 to a temperature over 450° C.

The heat energy recycling device 10 of the present invention further comprises a temperature sensor 30 to detect the temperature of the cylinder 17. The detected temperature is provided for the control computer 28 as a reference.

The exhausted gas generated by fuel combustion and the exhaust vapor of a water dynamic stroke contains water and carbon dioxide. The water vapor will condense and become liquid water at a temperature below 100° C. The condenser 12 is to recycle water and provide the recycled water for the water dynamic stroke. Thereby, the frequency of refilling water into the water tank 20 or the amount of the water refilled into the water tank 20 can be reduced.

The engine 16 shown in FIG. 2 comprises: a cylinder 17 having a fuel injector 31, a piston 32 and an intake device 34; and a crank chamber 36 arranged below the cylinder 17, airtightly connecting with the cylinder 17 and having a crank shaft 38, wherein the piston 32 is coupled to the crank shaft 38 with a piston connecting rod 40.

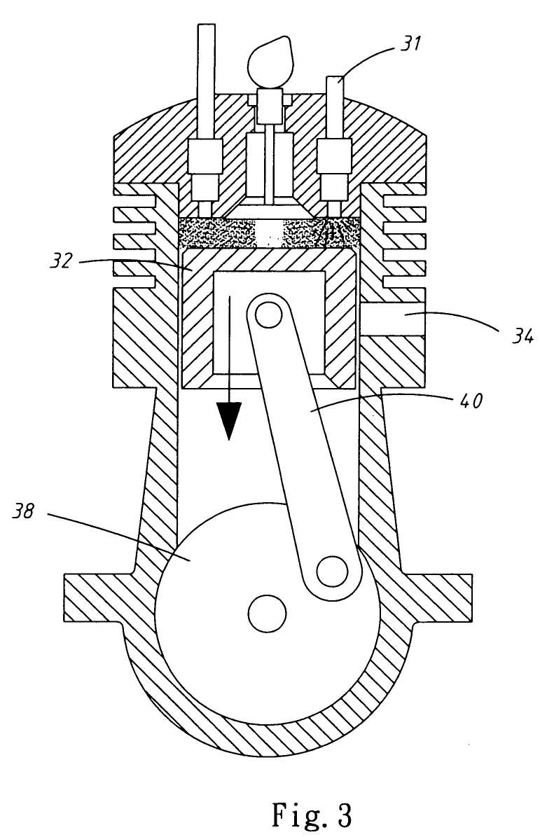

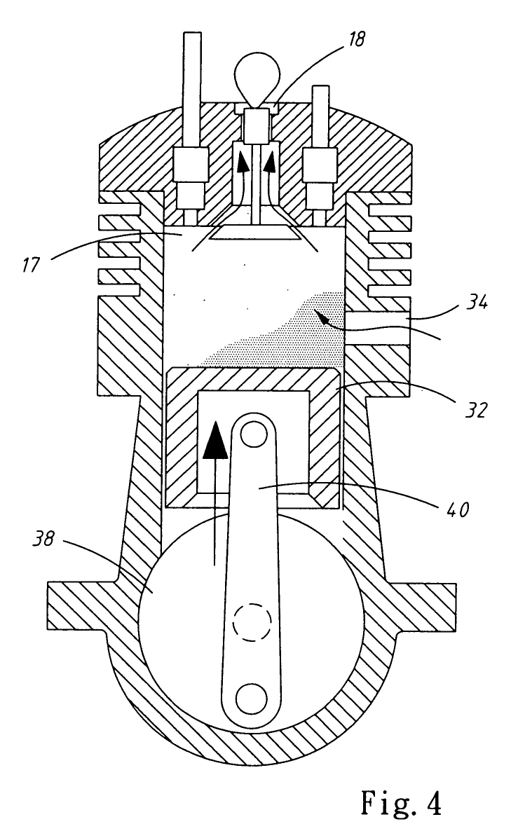

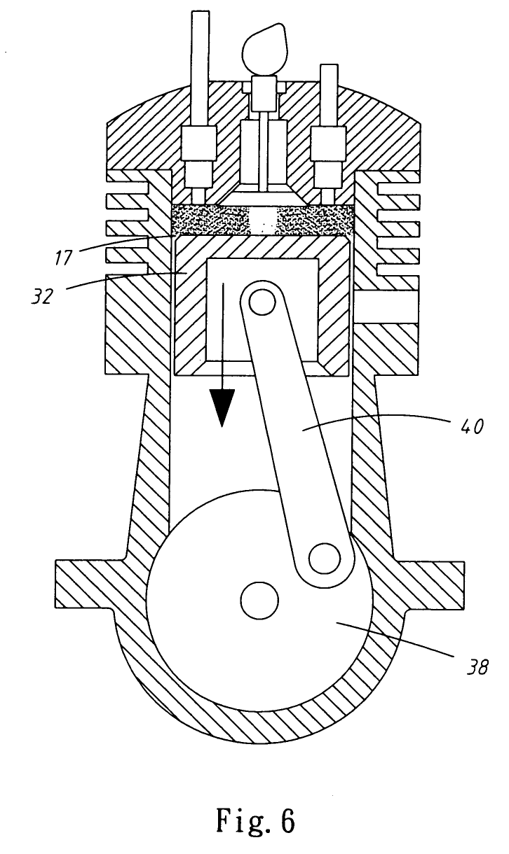

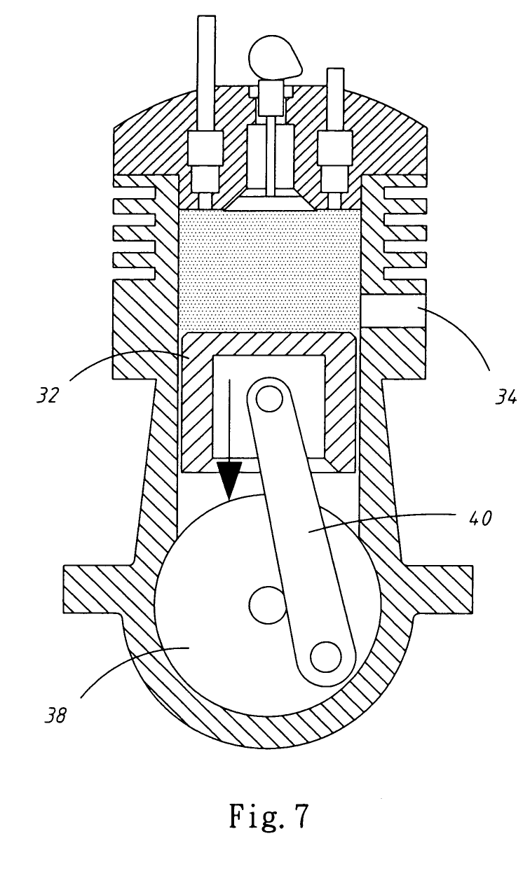

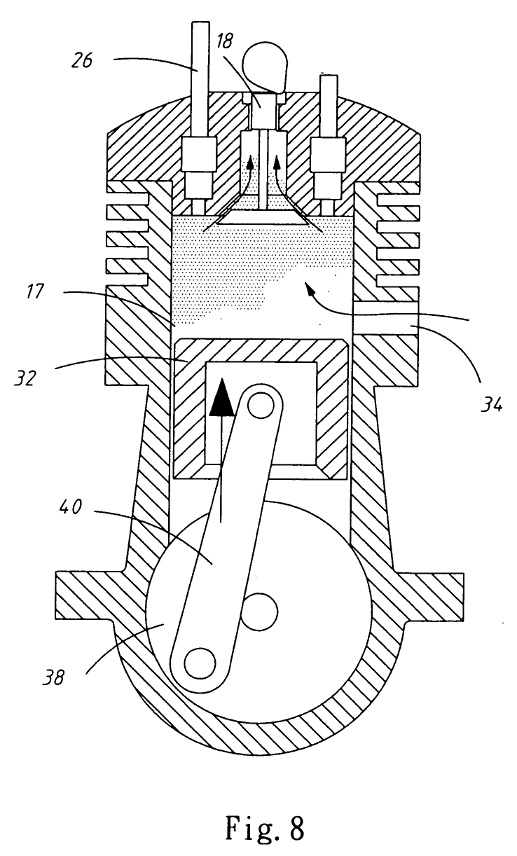

Refer to from FIG. 1 to FIG. 8 diagrams schematically showing that a two-stroke engine using the heat energy recycling device of the present invention performs fuel dynamic strokes and water dynamic strokes. Firstly refer to FIG. 3 and FIG. 4 diagrams schematically showing that a two-stroke engine using the heat energy recycling device of the present invention undertakes a fuel dynamic stroke. The fuel injected by the fuel injector 31 mixes with the air inside the cylinder 17 to form a fuel-containing gas. Then, the piston 32 approaches the top dead center; none gas flows into the cylinder 17 or crank chamber 36 because they are completely closed at this time. Once the compressed fuel-containing fuel is ignited, the explosive pressure drives the piston 32 to move downward, and the piston connecting rod 40 is pushed by the piston 32 to drive the crank shaft 38 to rotate. As the fuel inside the cylinder 17 is still burning, the combustion gas pushes the piton 32 from the top dead center toward the bottom dead center, the exhaust outlet 18 opens, and the high-pressure combustion gas is expelled by its own pressure from the exhaust outlet 18 to the exhaust device 14. Then, the intake device 34 begins to allow air to enter the cylinder 17. And expel more exhausted gas out of cylinder.

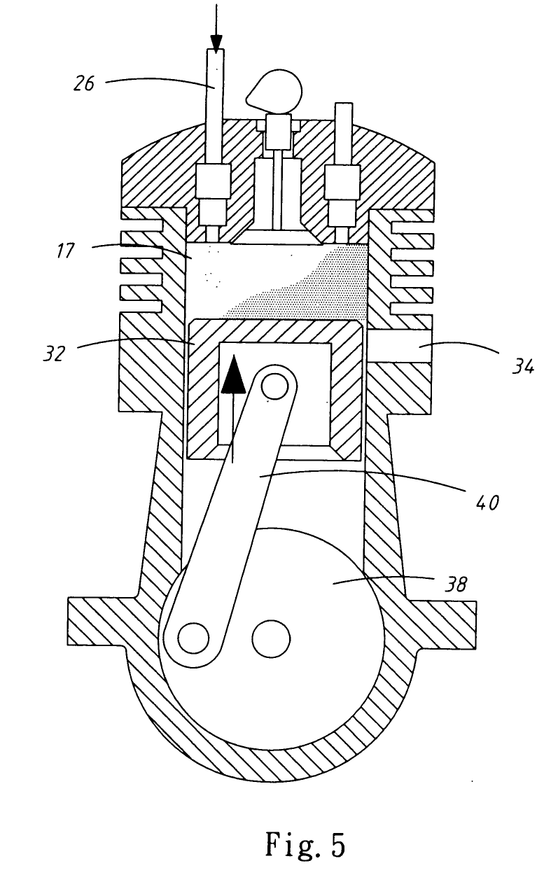

Next, the piston 32 moves from the bottom dead center toward the top dead center. At the same time, the control computer 28 detects whether the engine 16 has enough heat energy to perform a water dynamic stroke. If the engine 16 has enough heat energy, the water dynamic stroke shown in from FIG. 5 to FIG. 8 begins to perform. Firstly, the normal fuel injection of the two-stroke engine is intermitted. Further, the high-pressure water injector 26 injects the super hot pressurized water into the cylinder 17 before the explosion stroke. The pressurized water absorbs the heat of the exhausted gas in the preceding step and thus restored heat energy. As the saturation temperature at the related pressure is lower than the temperature of the high-pressure and high-temperature water, the water vaporizes by its own and the pressed hot air heat energy instantly to push the piston 32 toward the bottom dead center. Then, the exhaust outlet 18 and the intake device 34 open to let water vapor enter the exhaust device 14. Thus is completed a water dynamic stroke. When the high-pressure and high-temperature water vapor performs the water dynamic stroke, the temperature of the vapor inside the cylinder 17 is descending because of expansion, and the temperature of the vapor will be lower than that of the cylinder 17 finally. Then, the vapor absorbs and recycles the heat energy of the cylinder 17 and piston 32 to keep it in vapor state. As the cylinder and piston is cooled down internally. Therefore, the urgency of installing a cooling system is reduced.

The present invention uses the heat energy of the engine 16 to heat the water injected by the high-pressure water injector 26. Therefore, a thermally insulating material (not shown in the drawings) may be used to envelop the engine 16 and reduce heat emission from the engine 16.

Below, embodiments are used to verify the efficacies of the heat energy recycling device of the present invention.

Suppose the atmospheric temperature is 25° C. (298°K in the absolute temperature), the atmospheric pressure 1 Bar, and the weight of a liter of air roughly 1 gram.

The following constants will be used in the description of the embodiments: the heat capacity ratio r is 1.4, the specific heat capacity of air 0.241 Cal/(g×°K), the specific heat capacity of water vapor about 0.49 Cal/(g×°K), 1 liter of air about 0.0448 mole, and 1 gram of water about 0.0555 mole.

The following equations will be used in the description of the embodiments:

The ideal gas equation: PV=nRT, wherein P is the pressure, V the volume, and n the number of moles, R the universal gas constant, and T the absolute temperature.

The compression-temperature equation: Tc=Ta×Rc^{(r-1)}, wherein Tc is the temperature after compression, Ta the initial temperature, and Rc the compression ratio.

The compression-pressure equation: Pc=Pa×Rc^{r}, wherein Pc is the pressure after compression, Pa the initial pressure, and Rc the compression ratio.

Suppose the compression ratio of an engine is 10.

When the volume is compressed from 1 liter to 0.1 liter, the temperature after compression is Tc=(273+25)×10^{(1.4-1)}=748.54°K (475.54° C.), and Delta T=475.54−25=450.54, and the pressure after compression is Pc=1×10^{1.4}=25.11 Bar.

After the abovementioned compression, 0.9 gram of hot water having a temperature of 748.54°K (475.54° C.) is injected into a cylinder. As the saturation temperature of water at pressure of 25.11 Bar is much lower than 748°K, the water vaporizes because by its own heat energy, and absorbs the heat energy of the high-temperature air inside the cylinder.

Because of the addition of water, the heat capacity ratio r is about 1.35. The resultant pressure is equivalent to the pressure resulting from that 0.9 times of air is added into 0.1 liter of air. In other words, the compression ratio is 1.9. Thus, the resultant pressure is Pc=25.11×1.9^{1.35}=60 Bar.

The vaporization of water results in the 60 Bar pressure. Meanwhile, the temperature also gradually decreases until the pressure and the saturation temperature of water reach a balance. In such a case, most of water will vaporize.

The work done by the engine is W=P×delta V. When the gas inside the cylinder expands from 0.1 to 1 liter, the total work done by the engine is

$${\int }_{0.1}^{1} ( Pp - Po ) d V$$

wherein Pp=the pressure after the addition of heat, and

Po=the pressure before the addition of heat.

It should be noted that 60 Bar is much greater than 25.11 Bar generated by compressing air.

With a rough calculation, the total work done by the engine in a cycle is about a dynamic energy of 860 joules.

Without the factor of cylinder temperature, the temperature of the water vapor will decrease to under 373°K (100° C.) in the moment that the piston downward movement and the water vapor expansion. In practice, when the water vapor inside the cylinder expands, the temperature of the water vapor will be lower than the saturation temperature. Thus, the water vapor begins to condense, and the pressure also begins to decrease, which hinders doing a work. In the fuel combustion stroke, about 30% of heat energy is absorbed by the cylinder, piston, and the devices contacting the high-temperature gas. If the heat energy is not dissipated via the radiator, the temperature of the cylinder, etc., will rise to over 1000° C. in a very short time. In considering the need of engine operation, the temperature of the cylinder, etc., should be controlled to around 100- 200° C. A general solution is to arrange water channels over the cylinder, and the radiator can thus dissipate the heat to the atmosphere. However, such a solution cannot effectively decrease the temperature of the cylinder. The heat on the internal surface of the cylinder is transferred to the atmosphere via the path of the cylinder wall, water and then the radiator. However, the heat convection is not uniform. In other words, some regions have too high a temperature, and some other regions have too low a temperature. Thus, a part of compressed fuel gas contacting a high-temperature region has a spontaneous combustion. The explosion of the ignited fuel gas will impact the spontaneous-combustion gas, which generates a knocking and hinders promoting the compression ratio. The piston is particularly hard to cool down and has a high temperature, which further raises the difficulty of promoting the compression ratio.

The present invention does not use the water channels and radiator to dissipate heat. In the present invention, heat is conducted from the cylinder and piston to the vapor having a temperature lower than that of the cylinder and piston to cool down the temperature of the cylinder and piston. In the expansion stage, vapor absorbs heat from the cylinder and piston to maintain the gaseous state and maintain the stability of the internal temperature of the cylinder. Therefore, the present invention can promote the compression ratio and increase the fuel-efficiency.

In the present invention, the computer determines when to stop fuel supply and start a water dynamic stroke. When to start a water dynamic stroke relies on the temperature of the engine, the load, the rotation speed, the fuel throttling state, and the atmospheric temperature. Thus, the application of the present invention is not limited by the mechanical structure but has a great flexibility.

A vehicle under a cruise control or at an idle state requires less dynamic energy. Increasing the proportion of the water dynamic stroke at this time can effectively recycle heat energy and greatly reduce fuel consumption. Besides, as after water dynamic stroke, hot residual gas no longer remain, increasing the proportion of the water dynamic stroke at a state of low load is helpful to eliminating the low-load knocking, which is apt to occur in a high compression two-stroke engine.

Further, the present invention can obviously decrease the internal temperature of an engine, particularly the temperature of the piston, and thus can reduce the knocking and favor realizing a high compression ratio two-stroke engine.

The preferred embodiments described above are only to exemplify the present invention but not to limit the scope of the present invention. Any equivalent modification or variation according to the shapes, structures, characteristics or spirit of the present invention is to be also included within the scope of the present invention.

What is claimed is:

1. A heat energy recycling device for an engine comprising:
a condenser;
an exhaust device having one end connecting with an exhaust outlet of an engine and another end connecting with said condenser;
a water tank recycling condensed water from said condenser;
a high-pressure water pump connecting with said water tank;
a high-pressure injection water conduit having one end connecting with said high-pressure water pump that pressurizes water inside said high-pressure injection water conduit; and
a high-pressure water injector connecting with another end of said high-pressure injection water conduit and injecting water into a cylinder of said engine to implement a water dynamic stroke.

2. The heat energy recycling device for an engine according to claim 1, wherein a control computer controls a timing of starting and stopping said high-pressure water injector.

3. The heat energy recycling device for an engine according to claim 2 further comprising a temperature sensor that detects temperature of said cylinder of said engine and provides detected temperature for said control computer as a reference.

4. The heat energy recycling device for an engine according to claim 1, wherein said engine is a two-stroke engine.

5. The heat energy recycling device for an engine according to claim 1, wherein said water tank can be refilled with water.

6. The heat energy recycling device for an engine according to claim 2, wherein said control computer controls water dynamic strokes according to a temperature of said engine, a load, a rotation speed, a fuel throttling state, and an atmospheric temperature.

7. The heat energy recycling device for an engine according to claim 1, wherein said exhaust device has a heat exchanger.

8. The heat energy recycling device for an engine according to claim 1, wherein said high-pressure injection water conduit is wound around a perimeter of said exhaust device or is arranged inside said exhaust device to heat water inside said high-pressure injection water conduit.

9. A two-stroke engine having a heat energy recycling device comprising:
a two-stroke engine further comprising
at least one cylinder including:
at least one exhaust outlet, and
at least one fuel injector; and
a heat energy recycling device further comprising:
a condenser;
an exhaust device having one end connecting with said exhaust outlet and another other end connecting with said condenser;
a water tank recycling condensed water from said condenser;
a high-pressure water pump connecting with said water tank;
a high-pressure injection water conduit having one end connecting with said water pump that pressurizes water inside said high-pressure injection water conduit; and
a high-pressure water injector arranged inside said cylinder, connecting with another end of said high-pressure injection water conduit and injecting water into said cylinder to implement a water dynamic stroke.

10. The two-stroke engine having a heat energy recycling device according to claim 9, wherein a control computer controls a timing of starting and stopping said high-pressure water injector.

11. The two-stroke engine having a heat energy recycling device according to claim 10, wherein a temperature sensor is installed in said cylinder of said engine, and said temperature sensor detects temperature of said cylinder of said engine and provides detected temperature for said control computer as a reference.

12. The two-stroke engine having a heat energy recycling device according to claim 9, wherein a thermally insulating material envelops said two-stroke engine.

13. The two-stroke engine having a heat energy recycling device according to claim 9, wherein said water tank can be refilled with water.

14. The two-stroke engine having a heat energy recycling device according to claim 11, wherein said control computer controls water dynamic strokes according to a temperature of said engine, a load, a rotation speed, a fuel throttling state, and an atmospheric temperature.

15. The two-stroke engine having a heat energy recycling device according to claim 9, wherein said exhaust device has a heat exchanger.

16. The two-stroke engine having a heat energy recycling device according to claim 9, wherein said high-pressure injection water conduit is wound around a perimeter of said exhaust device or is arranged inside said exhaust device to heat water inside said high-pressure injection water conduit.
